(19) United States
(12) Patent Application Publication
(10) Pub. No.: US 2015/0354973 A1
(43) Pub. Date: Dec. 10, 2015

(54) MAP MATCHING

(71) Applicant: HEWLETT-PACKARD DEVELOPMENT COMPANY, L.P., Houston, TX (US)

(72) Inventors: Yin Wang, Sunnyvale, CA (US); Hong Wei, Sunnyvale, CA (US); George Forman, Port Orchard, WA (US)

(21) Appl. No.: 14/759,977

(22) PCT Filed: Mar. 15, 2013
(86) PCT No.: PCT/US2013/032638

§ 371 Date: Jul. 9, 2015

(51) Int. Cl. G01C 21/30; G01S 19/13

(52) U.S. Cl. CPC G01C 21/30; G01S 19/13

(57) ABSTRACT

An example map matching technique in accordance with the present disclosure includes receiving a plurality of global positioning system (GPS) data points in a dataset, receiving road map data related to a plurality of roads, determining a plurality of paths of minimum Fréchet distance for the GPS dataset, assigning a weight to each path of minimum Fréchet distance by applying a weight function, and outputting the path with the minimum weight.

### BACKGROUND

Navigation systems provide information helpful for driving a vehicle using a satellite. A navigation system includes a GPS (global positioning system) module that receives a GPS signal from a GPS satellite and calculates a location of a vehicle based on the GPS signal. GPS receivers are integrated into navigation devices, vehicle telematics systems, and smart phones. Due to their inherent measurement error, map matching is used to pinpoint the correct location on the road network. Many GPS-related applications require map matched data, e.g., traffic monitoring, event detection and road quality assessment.

Map matching methods use inputs generated from positioning technologies (such as GPS or GPS integrated with dead reckoning) and supplement this with data from a road network map to provide an enhanced positioning output. The process of map matching takes a sequence of possibly noisy GPS coordinates from a vehicle trace and estimates the actual road positions, identifying the correct road segment on which the vehicle is travelling and to determine the vehicle location on that segment. This is an important first step used by many GPS applications.

Various GPS systems have different sampling rates. The difficulty of map matching can greatly differ depending on GPS accuracy and the sampling rate. For example, a navigation system may receive GPS information from the GPS receiver at a high sampling rate of once per 1 second or faster, or a slow sampling rate of once per 10 seconds or slower (e.g., 60 seconds), and screen update due to vehicle movement is performed only once per second despite operating at high speeds.

### BRIEF DESCRIPTION OF THE DRAWINGS

Examples are described in the following detailed description and in reference to the drawings, in which:

FIG. 1 illustrates a block diagram of an example system used for map-matching in accordance with an implementation;

FIG. 2 illustrates an example map matching module in an example system in accordance with an implementation; and

FIG. 3 illustrates an example process flow diagram in accordance with another implementation.

### DETAILED DESCRIPTION

Various aspects of the present disclosure are generally directed to map matching. More specifically, various aspects of the present disclosure are directed to map matching that combines geometric methods with minimum weight methods. As described in greater detail below, this approach integrates map matching based on a Fréchet distance measure with global weight optimization. This approach eliminates the need for extensive tuning of the parameters and allows robust performance across datasets of different characteristics.

Aspects of the present disclosure described herein determine the minimum Fréchet distance for an input GPS trace, and choose the minimum weight path among all minimum distance paths. Among other things, this approach may perform consistently against varying sampling rates and accordingly prevent the difficulty of map matching that greatly differs depending on GPS accuracy and the sampling rate.

In one example in accordance with the present disclosure, a map matching method is provided. The method comprises receiving a plurality of global positioning system (GPS) data points in a dataset, receiving road map data related to a plurality of roads, determining a plurality of paths of minimum Fréchet distance for the GPS dataset, assigning a weight to each path of minimum Fréchet distance by applying a weight function, and outputting the path with the minimum weight.

In another example in accordance with the present disclosure, a map matching system is provided. The system comprises a processor, a memory coupled to the processor, and a map matching module stored in the memory and executed on the processor to receive a plurality of global positioning system (GPS) data points in a dataset, determine candidate road locations for each GPS data point, each candidate road location being a projection to a road within a radius, calculate shortest paths from each candidate road location associated with a first GPS data point to the candidate road locations associated with a second GPS data point, select a path with minimum weight according to a weight function, the weight function being based on the calculated shortest paths, and output the path with the minimum weight.

In a further example in accordance with the present disclosure, a non-transitory computer readable medium is provided. The non-transitory computer-readable medium comprises instructions which, when executed, nausea device to (i) receive a plurality of global positioning system (GPS) data points in a dataset, (ii) determine a plurality of paths of minimum Fréchet distance for the GPS dataset, (iii) assign a weight to each path of minimum Fréchet distance by applying a weight function, and (iv) output the path with the best weight.

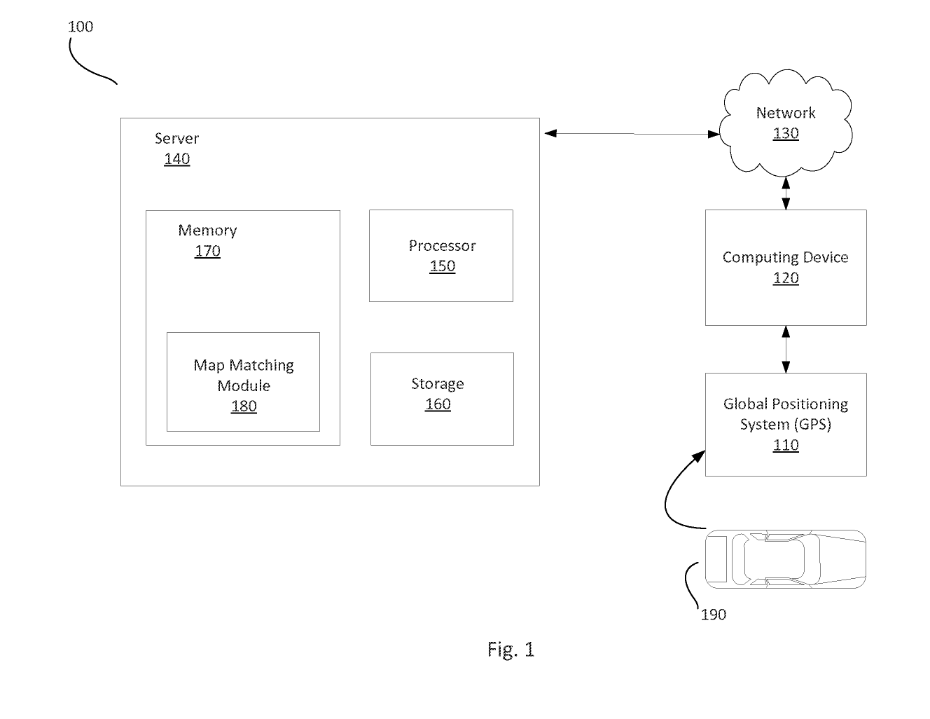

FIG. 1 illustrates an example system framework 100 which is used for map matching in accordance with an implementation. The map matching framework 100 comprises a Global Positioning System (GPS) 110, a computing device 120, a network 130, and a server 140, it should be readily apparent that the present illustration should not be interpreted to be limited by this particular illustrative architecture shown in FIG. 1, and the system 100 represents a generalized illustration and that other elements may be added or existing elements may be removed, modified, or rearranged without departing from the scope of the present disclosure. For example, while the system 100 depicted in FIG. 1 includes only one computing device, the system may actually comprise a plurality of computing devices, and such devices may be connected via a cellular telephone network. Only one has been shown in FIG. 1 and described herein for simplicity.

The GPS 110 may collect location data (e.g., GPS trajectories) over time as the computing device 120 moves from one location to another. The GPS 110 may receive GPS information from a GPS satellite. In one implementation, a sequence of GPS datasets (e.g., samples) consisting of a set of GPS data points may be depicted as z₀, z₁, . . . , zₙ. The GPS data points may comprise a sequence of positions with latitude, longitude, instant speed, direction and timestamp information.

The GPS 110 may move with the user 190 in a vehicle. In one implementation, the GPS 110 may be a stand-alone device. In another implementation, the GPS 110 may exist in the computing device 120. For example, the GPS 110 may be implemented as a component of a web browser or a search engine, or may be implemented as an application in the computing device 120. In some implementations, the GPS 110 may receive location data upon detecting a satellite signal based on a pre-determined rate. For example, the GPS 110 may record data every 30 seconds, every 5 minutes, or the like.

The computing device 120 may be any device capable of processing information and communicating over the network. The computing device 120 may include, but not limited to, a portable handheld computing device (e.g., a personal digital assistant, a smart phone, a cellular phone), a laptop computer, a desktop computer, a media player, a digital camcorder, an audio recorder, a camera, or any other device capable of connecting to the network 130. The computing device 120 may have one or a plurality of users.

In one implementation, the computing device 120 may include, but not limited to, a processor, a memory, and one or more communication interfaces. In addition or alternatively, the computing device 120 may have an operating system, and a user interface (UI) module. In another implementation, a display device may be connected to the computing device 120. When executed on the processor, the operating system and UI module collectively facilitate presentation of a user interface on the display device. In a further implementation, the display device may be incorporated into the computing device 120.

The network 130 may represent any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network 130 may also include traditional landline or a public switched telephone network (PSTN), or combinations of the foregoing (e.g., Unlicensed Mobile Access or UMA networks, circuit-switched telephone networks or IP-based packet-switch networks).

The server 140 may be an example server within the map matching framework 100. The server 140 may include, without limitation, a processor 150, a storage unit 160, and a memory 170. A map matching module 180 may be maintained in the memory 170 and executed on the processor 150. In one implementation, the map matching module 180 may include a road network database (not shown in FIG. 1) that includes, without limitation, information pertaining to at least geographical locations within roadway systems. For example, the road network database may contain a mapping of the roadways of the greater Seattle or Shanghai area including service roads, highways, and any other roads available to the user 190.

In another implementation, the server 140 may comprise at least one communication interface (not shown in FIG. 1) to allow the processor 150 to communicate with the computing device 120, other network servers, network storage, and/or other devices over the network 130.

The processor 150 may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on memory 170, or a combination thereof. The processor 150 may fetch, decode, and execute instructions stored on the memory 170 to implement the functionalities described above.

The storage unit 160 may store the GPS data collected by the GPS 110 and sent to the server 140. For example, the GPS data may be stored in GPS logs. In another implementation, the server 140 may also include one or more known input device(s) (not shown in FIG. 1), such as a keyboard, a mouse, a pen, a voice input device, a touch input device, and an output device such as a display, speaker, printer, or the like.

The memory 170 may be an example non-transitory computer-readable medium. The non-transitory computer-readable medium may store machine-readable instructions, such as programming code, software, firmware, or the like. For example, the computer-readable medium may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that can be executed by the processing device. In this case, the computer-readable medium may be a portable medium, or flash drive or a memory maintained by a server from which the installation package can be downloaded and installed. In another implementation, the instructions may be part of an application or application already installed. Here, the computer-readable medium may include integrated memory such as a hard drive.

The memory 170 may include the map matching module 180, which may be executed on the processor 150. The map matching module 180 may receive a sequence of GPS data points associated with the user 190 and a map of the road network. The map matching module 180 may output a sequence of estimated locations of the user 190, such as specific road segments. In one implementation, the map matching module 180 may be connected to the computing device 120 through the network 130 and the GPS 110. The map matching module 180 may deliver the output of a sequence of estimated locations of the user 190 to the computing device 120 for such information to be presented to the user 190. In addition or alternatively, the map matching module 180 may deliver the output sequence of estimated locations to the computing device 120 to be stored in a database in the computing device 120.

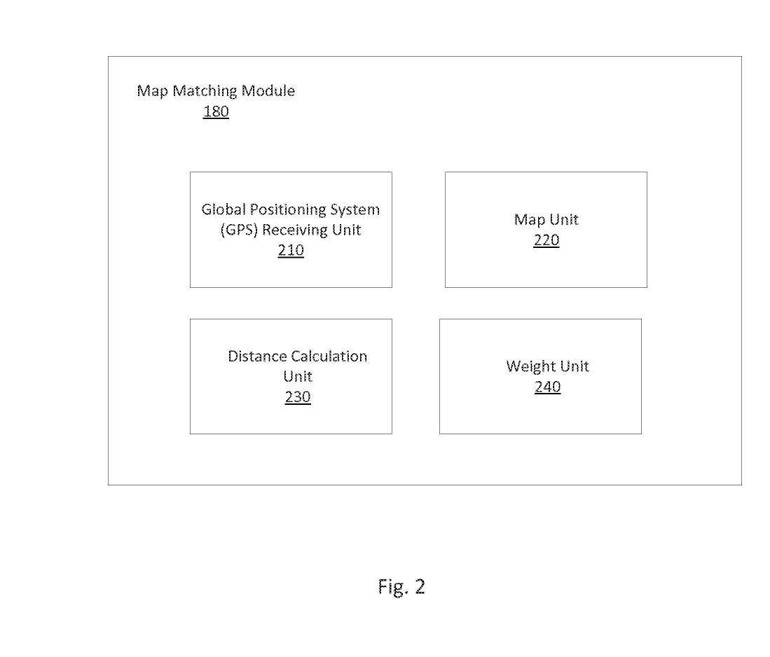

FIG. 2 is a block diagram illustrating the example map matching module 180 of FIG. 1, in accordance with an implementation. It should be readily apparent that the map matching module 180 illustrated in FIG. 2 represents a generalized depiction and that other components may be added or existing components may be removed, modified, or rearranged without departing from a scope of the present disclosure. The map-matching module 130 described herein comprises a number of units, each with a particular role, as shown in FIG. 2. These units can be either functions within the computer program product described herein, sub-methods of the method described herein, and/or elements of the system described herein—each of which is described in greater detail below. The map matching module 180 includes a GPS receiving unit 210, a map unit 220, a distance calculation unit 230, and a weight unit 240, each of which is described in greater detail below. While FIG. 2 illustrates four units, there may be additional units or the illustrated units may be structured differently. Also, although 2 shows all of these components within a single device (i.e., the map matching module 180), the components may be physically distributed across multiple devices.

The GPS receiving unit 210 may obtain data from a GPS device (as illustrated in FIG. 1 as the GPS 110) or GPS logs that may be stored in a database (as illustrated in FIG. 1 as the computer 120 or the storage device 160). In one implementation, the GPS datasets (e.g., trajectory data or sampling points) may be collected by the computing device 120 and communicated to the map matching module 180 through the network 130. As discussed above, a GPS dataset (e.g., sampling points) consisting of a set of GPS data points may be depicted as z₀, z₁, . . . , zₙ.

The map unit 220 may obtain data from the road network database in the map matching module 180. The map unit 220 may export a map of the road network. In one implementation, the map may be represented by a set of roads, and each road may be represented as a polyline, i.e., a sequence of line segments. The map unit 220 may determine the candidate projection points. For each GPS data point zᵢ, the map unit 220 may determine a set of candidate locations {xᵢ⁰, xᵢ¹, . . . }, which are the perpendicular projections on road segments {yᵢ⁰, yᵢ¹, . . . }, within a radius or an error eclipse of zᵢ.

The search radius parameter may be used to find candidates for each sample. In one implementation, the radius may be calculated based on a set of data points and their ground-truth road. A small radius may miss the ground truth location, and a large radius may significantly slow down the map-matching process due to the lame number of candidates growing quadratically. For example, a histogram of the distance between each sample and its ground-truth road may show a maximum error of 25.5 m. Accordingly, the candidate search radius may be set to 50 m, about twice the maximum error.

The distance calculator unit 230 may find the paths on the map that have a minimum Fréchet distance to the GPS dataset. The Fréchet distance between two curves may be described as the minimum required length of a tether between two points as they traverse the two curves, respectively, without backtracking. In one implementation; the Fréchet distance between two curves f, g:[0; 1]→R² may be defined as:

δ_{F}(f,g):=inf_{α,β:[0,1]→[0,1]}max_{tε[0,1]}∥f(α(t))−f(β(t))∥ Equation (1)

where α and β are continuous and non-decreasing time-warping functions with α(0)=β(0)=0 and α(1)=1.

In one implementation, a conventional free-space diagram may be used for calculating the Fréchet distance of two curves. The free-space diagram between two curves for a given distance threshold ε may be a two-dimensional region in the parameter space that consists of all point pairs on the two curves at distance at most ε.

As discussed above, the roads may be represented as polylines; which may be used to approximate curved paths. The free space between two polylines may generalize to the free space between a planar graph G=(V, E) of the road network and a polyline Z=(z₀, z₁, . . . , zₙ) of the GPS dataset. A path may exist in G with Fréchet distance at most ε to Z if and only if a monotone path exists in the horizontal and in the vertical direction on the free space surface. In one implementation, a monotonic function may be described as one that either never increases or never decreases.

In one implementation, to determine whether a path on G with Fréchet distance at most Σ to Z exists, the free space surface may be constructed, and the free space may be identified by calculating all free space intervals in the free space diagram of two line segments. The sub free space that is monotone according to the topology of G (following the direction of edges in E) and monotone from G₀ to Gₙ (following the direction of Z) may be calculated. It may be concluded that the path exists if and only if a free space interval on Gₙ exists.

Algorithm 1, set forth below, outlines an example algorithm for calculating the monotone free (i.e., white) space, which may be exactly the region reached by all monotone paths starting from free space intervals on G₀, using the map matching module 180.

Algorithm 1 Calculating the monotone white space

| Input: A free space surface for trace (z₀, ..., zₙ) and | |
|---|---|
| | graph G = (V, E), with all (non-monotone) white |
| | intervals calculated |
| Output: Updated white intervals marking the mono- | |
| | tone white space |
| 1: | for i = 0, ..., n − 1 do |

| | |
|---|---|
| 2: | for all edge (μ, ν) ∈ E do |

| | |
|---|---|
| 3: | if vertical interval Iᵢ^{(μ, ν)} is not empty then |

| | |
|---|---|
| 4: | mark horizontal interval Iᵢ [symbol] as visited |

| | |
|---|---|
| 5: | end if |

| | |
|---|---|
| 6: | end for |
| 7: | sweep from Gᵢ to Gᵢ₊₁ and update horizontal |
| | intervals not visited yet from already visited |
| | horizontal intervals, according to the topology of |
| | G, and mark them as visited. |
| 8: | for all vertex μ ∈ V do |

| | |
|---|---|
| 9: | if horizontal interval Iᵢ^{μ} is not visited then |

| | |
|---|---|
| 10: | empty Iᵢ^{μ} |

| | |
|---|---|
| 11: | end if |
| 12: | for all vertex ν ∈ V, (μ, ν) ∈ E do |

| | |
|---|---|
| 13: | update vertical interval Iᵢ₊₁^{(μ, ν)} from vertical |
| | interval Iᵢ^{(μ, ν)} and horizontal interval Iᵢ^{μ} |

| | |
|---|---|
| 14: | end for |

| | |
|---|---|
| 15: | end for |

| | |
|---|---|
| 16: | end for |

[symbol]

indicates data missing or illegible when filed

In one implementation, the minimum Fréchet distance to Z may be found by binary search. For example, multiple candidate values may be calculated in a binary search. In another implementation, the minimum Fréchet distance to Z may be found by a parametric search. In a further implementation, the binary search may be stopped when the remaining interval is shorter than a threshold, without finding the exact Fréchet distance. For example, the threshold may be set to 1 meter.

In one implementation, after the binary search identifies an approximate minimum Fréchet distance, there may still be multiple monotone paths on the free space surface with equal Fréchet distance to the polyline Z. Where multiple monotone paths are found on the free surface, the weight unit 240 may determine the most probable match for a sample by calculating a weight for each candidate path. In one implementation, the weight unit 240 may use dynamic programming to assign weights to these paths and return the minimum weight. For example, the weight unit 240 may use Viterbi dynamic programming to find the minimum weighted path among all paths with minimum Fréchet distance. The dynamic programming may eliminate the explicit enumeration of all candidate paths, which can be exponential in the length of the input trace. Using the dynamic programming method, the solution may be computed once and stored, and the next time the same solution is needed, it may simply be looked up. Accordingly, for each candidate path match of each GPS sample, the minimum weight path may be calculated only once and remembered to find the candidate path again.

In one implementation, the weight unit 240 may perform a weight function represented by:

arg min(x₀,x₁, . . . ,xₙ)Σᵢ₌₀ⁿtᵢdᵢ²+αLᵢ Equation (2)

where tᵢ is the time interval between zᵢ and zᵢ₋₁ (but t₀=t₁ or some constant, such as 1.0), dᵢ is the distance between xᵢ and zᵢ, α is a constant parameter, and Lᵢ is the shortest-path distance between xᵢ and xᵢ₋₁ in the map (but L₀=0).

It should be noted that the summation of Lᵢ for a candidate sequence is the Length of the shortest path that links it, which does not change with the sampling interval. It should also be noted that the expected value of the summation of tᵢdᵢ² does not depend on the sampling interval either. Therefore, the ratio between these two terms remains the same for differing sampling intervals, and a constant α performs consistently across all sampling intervals. It should further be noted that the time elapsed between consecutive samples is encountered in the weight function set forth above. Accordingly, the weight function is consistent for input traces with variable sampling rates or with occasionally missing GPS points.

In one implementation, the weight calculation may be based on two features: distance d and shortest-path L. Distance may measure the great circle distance between a sample zᵢ and a candidate location xᵢ^{j}. Shortest-path may be calculated based on the length of the shortest path from xᵢ₋₁^{k} to xᵢ^{j}. It will be appreciated to those skilled in the art that in other implementations, additional features may be considered in the weight function. For example, the weight may include factors, such as the alignment between measured bearing and road direction, the direction indicating the angle difference between a line segment of a sample zᵢ and the road segment, and the speed calculated by the length of the shortest path between two candidates divided by the sampling interval.

In one implementation, the weight unit 240 may tune the constant parameters in the weight function to maximize its accuracy for the dataset.

Algorithm 2, set forth below, outlines an example method for finding the minimum weight path on a free surface via dynamic programming.

| Input: A free space surface for trace (z₀, . . . , Zₙ) and | |
|---|---|
| | graph G = (V, E), with the monotone white space |
| | calculated, and the global weight function to |
| | minimize Σᵢ₌₀ⁿ (x(dᵢ) + y(lᵢ)) |
| Output: The min-weight path on the surface | |
| 1: | for all edge (μ, ν) ε E do |
| 2: | I₀^{(μ, ν)}, weight = x(d₀^{(μ, ν)}) |
| 3: | end for |
| 4: | for i = 1, . . . , n do |
| 5: | for all vertex ν ε V do |
| 6: | Iᵢ₋₁^{ν}, weight = |
| | ${min}_{[ μ \vert ( μ , ν ) ε E ]} ( {I}_{i - 1}^{( μ , ν )} , weight + y ( ( μ , ν ) , length ) )$ |
| 7: | end for |
| 8: | update Iᵢ₋₁^{ν} weight for all ν ε V from each other |
| | based on topology of G using a procedure |
| | similar to Dijkstra's shortest-path algorithm |
| 9: | for all edge (μ, ν) ε E do |
| 10: | Iᵢ^{(μ, ν)}, weight = |
| | min {Iᵢ₋₁^{μ}, weight, Iᵢ₋₁^{(μ, ν)}, weight} + x(dᵢ^{(μ, ν)}) |
| 11: | end for |
| 12: | end for |
| 13: | return min-weight path reconstruction |

The weight unit 240 may set the weight for each free space interval I₀^{(u,v)} on G₀, which is calculated from the distance between z₀ and the edge corresponding to I₀^{(u,v)}, denoted as d₀^{(u,v)} in Line 2 of the algorithm as set forth above. The weight is set to negative infinity if I₀^{(u,v)} is an empty interval. The main forward loop from Lines 4 to 12 assigns the minimum weight to each free space interval via dynamic programming. Lines 5 to 7 assign the initial weight to a horizontal interval by comparing all the adjacent cells of Iᵢ₋₁^{v}, corresponding to adjacent edges of v in G. The weight calculated from the length of (u, v) may be added to the cell corresponding to (u; v) since the path has moved from vertex u to v. Line 8 updates the weights of horizontal intervals from other horizontal intervals using the initial weights and following the topology of G. Lines 9 to 11 update a vertical interval on G, from the parallel vertical interval and the bottom horizontal interval of the cell it belongs to. Finally, Line 13 reconstructs the paths backward, from the min-weight interval on Gₙ to the interval on G₀, following the pointer stored at each interval. In one implementation, a monotone path goes through G₀, . . . Gn. Moreover, the vertical interval that the path goes through may be Iᵢ^{(u,v)} at Gᵢ, and accordingly, sample zᵢ may be matched to road (u, v). The sequence of free space horizontal intervals (corresponding to vertices in G) that the monotone path goes through forms a path in G, which is the highest weight path with Fréchet distance no more than ε to trace Z.

The map matching module 180 may include a map parser (not shown in FIG. 2). In one implementation, the map parser may read the GPS data points and build a bounding rectangle that encloses all the points. The map parser may bypass roads outside of the rectangle and may parse the roads inside the rectangle. In another implementation, the map parser may use a string scanner used to parse numerical characters only, excluding special cases such as NaN (not a number). In a further implementation, the map parser may parse each input line in parallel, which may result in an optimized parsing speed for the map parser.

As discussed above in more detail, Viterbi dynamic programming may be used to calculate the shortest path for every consecutive pair of match candidates. In one implementation, the speed optimizing approach may be used to improve the speed of the Viterbi dynamic programming and reduce the computation time associated with the programming. For example, in one implementation, there may be n candidates for sample zᵢ and m candidates for sample zᵢ₊₁. Accordingly, in this implementation, a total of n*m shortest paths may need to be calculated. In another implementation, the map matching module 180 may calculate all shortest paths from each candidate of zᵢ to all m candidates of zᵢ₊₁ at once. Therefore, the map matching module 180 runs the calculations only n times, instead of n*m times as a way of adapting the Dijkstra algorithm. Further, in one implementation, each calculation may be performed in parallel.

In another implementation, the shortest-path search range may be limited. For example, the range may be set to a threshold that is equal to the sampling interval of the GPS datasets multiplied by a predetermined speed (e.g., 50 m/s). In addition or alternatively, the candidate search may be limited by setting the radius to a predetermined threshold to reduce the size of candidate sets. For example, the radius may be set to 30 m if it is determined that the largest distance between a sample and its matched road is around 25 m.

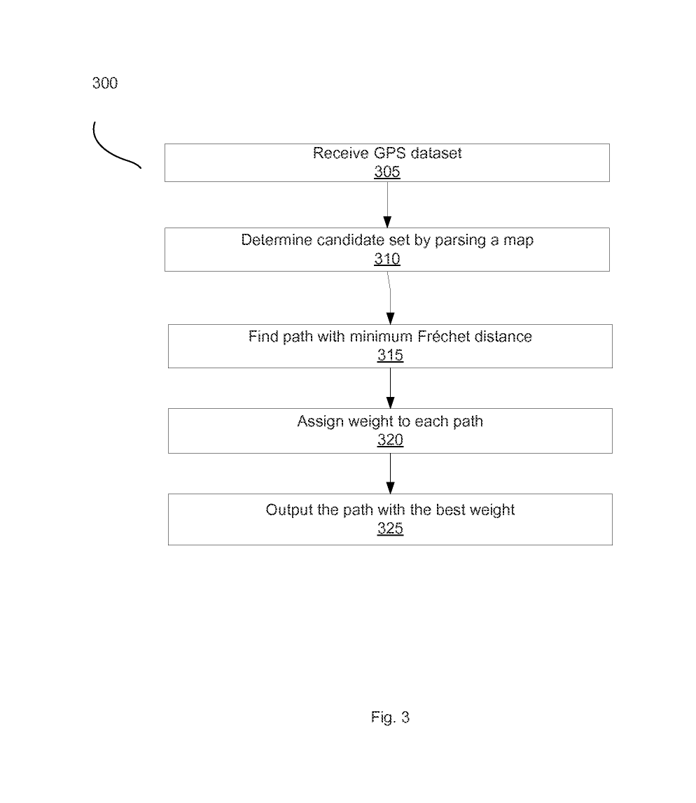

Turning now to the operation of the system 100. FIG. 3 depicts an example process flow diagram 300 illustrating the map matching procedure set forth above in accordance with an exemplary implementation of the present disclosure. It should be readily apparent that the processes depicted in FIG. 3 represents generalized illustrations, and that other processes may be added or existing processes may be removed, modified, or rearranged without departing from the scope and spirit of the present disclosure. Further, it should be understood that the processes may represent executable instructions stored on memory that may cause a processing device to respond, to perform actions, to change states, and/or to make decisions. Thus, the described processes may be implemented as executable instructions and/or operations provided by a memory associated with a map matching module 180.

The process 300 may begin at block 305, where a system for determining a match between a GPS dataset and a road location receives GPS information. In particular, this process may involve receiving the GPS information from a GPS satellite at predetermined intervals. In one implementation, the set of sampling points may be sent by the GPS 110 and/or the computing device 120 over the network 130. As discussed above in detail with reference to FIG. 1, each sample consists of a timestamp and a longitude-latitude pair.

At block 310, the system performs a candidate computation, the results of which may be used to determine candidate sets. In particular, this process may involve exporting a road map such as OpenStreetMap (OSM). This process may further involve accessing a road network database to determine one or more corresponding road segments using the candidate points. As discussed above, the road may be represented as polylines. In one implementation, this process may verify the existence of the roads through a ground-truth process by relating the image data of the roads to actual roads. The ground-truth of the dataset may match each sample to a road ID, which typically represents a section of road between two adjacent intersections. More specifically, this process may further involve parsing the map by building a bounding rectangle that encloses all the received GPS data points, bypassing the roads outside the rectangle, and implementing a string scanner to parse each input line.

In another implementation, the process at block 310 may also involve limiting the candidate search radius to a predetermined threshold in order to reduce the size of candidate sets.

At block 315, the system identifies the paths on the map that has minimum Fréchet distance to the GPS dataset. As discussed above, a path may exist with minimum Fréchet distance if and only if a monotone path exists on the free space surface between the road network and the GPS dataset. On the basis of this, the map matching module 180 uses Algorithm 1, described above, to calculate the monotone free space. In addition, as discussed above in more detail in reference to FIG. 2, a binary search may be applied to determine an approximate minimum Fréchet distance.

At block 320, the system calculates and assigns a weight for each path identified at block 315. In particular, this process may involve performing a weight function represented by Equation 1 as described above in reference to FIG. 2.

Moreover, this process may involve dynamic programming analysis. Which is performed on the candidate paths to find the minimum weighted path among all paths with minimum Fréchet distance. In one implementation, the system may limit the path range by setting it to be the sampling interval multiplied by a predetermined speed in order to reduce the computation time.

The process at block 320 may also involve using Algorithm 2, described above, to determine which path has the minimum weight on a free surface, and therefore has the best weight and is the best match to the GPS dataset.

In response to the weight assignments, at block 325, the system outputs the candidate sequence with the best weight. In particular, this process may involve storing information related to the path with the minimum weight in a database. In one implementation, such information may be used to support external applications such as location management or driving directions.

In addition or alternatively, the process may include visualizing the results on an interface that can be tailored towards different end-user devices of the user 190. As discussed above, in one implementation, the output may be delivered to the computing device 120 to be displayed to the user 190. In another implementation, a display device attached the map matching module 180 may be utilized to display the visualization.

While the above disclosure has been shown and described with reference to the foregoing examples, it should be understood that other forms, details, and implementations may be made without departing from the spirit and scope of the disclosure that is defined in the following claims.

What is claimed is:

1. A processor-implemented map matching method, comprising:
receiving a plurality of global positioning system (GPS) data points in a dataset;
receiving road map data related to a plurality of roads;
determining a plurality of paths of minimum Fréchet distance for the GPS dataset;
assigning a weight to each path of minimum Fréchet distance by applying a weight function; and
outputting the path with the minimum weight.

2. The method of claim 1, wherein each GPS data point comprises a combination of a timestamp, a longitude-latitude pair, speed and bearing.

3. The method of claim 1, further comprising determining a candidate road location from the plurality of roads for each GPS data point, the candidate road location being a projection to a road within a radius.

4. The method of claim 1, wherein determining the minimum Fréchet distance for the GPS dataset further comprises calculating values for the plurality of roads, and applying binary search.

5. The method of claim 4, further comprising stopping the binary search when the remaining range of values is shorter than a pre-determined threshold.

6. The method of claim 1, wherein assigning the weight to each path of minimum Fréchet distance by applying the weight function further comprises using the weight function to compute the weight for each path based on distance and shortest path.

7. The method of claim 6, wherein assigning the weight to each path of minimum Fréchet distance by applying the weight function further comprises selecting the weight function to be robust against GPS datasets with variable sampling rates.

8. The method of claim 7, wherein the weight function selects the path with minimum weight according to the function:
arg min(x₀,x₁, . . . ,xₙ)Σᵢ₌₀ⁿtᵢdᵢ²+αLᵢ.

9. The method of claim 1, wherein assigning the weight to each path of minimum Fréchet distance by applying the weight function further comprises using dynamic programming to avoid explicit enumeration of each path of minimum Fréchet distance.

10. The method of claim 9, wherein the dynamic programming comprises Viterbi dynamic programming.

11. The method of claim 1, wherein outputting the path with the best weight further comprises comparing the weight for each path of minimum Fréchet distance, and identifying the path with the minimum weight.

12. A map matching system, comprising:
a processor;
a memory coupled to the processor; and
a map matching module stored in the memory and executed on the processor to:
receive a plurality of global positioning system (GPS) data points in a dataset;
determine candidate road locations for each GPS data point, each candidate road location being a projection to a road within a radius;
calculate shortest paths from each candidate road location associated with a first GPS data point to the candidate road locations associated with a second GPS data point, the first GPS data point and the second GPS data point being consecutive; and
select a path with minimum weight according to a weight function, the weight function being based on the calculated shortest paths.

13. The system of claim 12, wherein the map matching module is further executed on the processor to process each calculation of the shortest paths from each road candidate associated with the first GPS data point to the candidates of the second GPS data point in parallel.

14. The system of claim 12, wherein the map matching module is further executed on the processor to:
determine a plurality of paths of minimum Fréchet distance for the GPS dataset.

15. The system of claim 12, wherein the map matching module is further executed on the processor to:
define a bounding rectangle enclosing the plurality of GPS data points; and
bypass road locations outside of the defined rectangle.

16. The system of claim 12, wherein the map matching module is further executed on the processor to:
limit a search range of a shortest path from a candidate road location to a GPS data point to a threshold calculated based on a predetermined speed and a sampling interval of the plurality of GPS data points.

17. The system of claim 12, wherein the map matching module is further executed on the processor to:
limit a search radius of the set of candidate road locations to a predetermined threshold to reduce the size of the candidates.

18. The system of claim 12, wherein the weight function selects the minimum weight path according to:
$$arg min ( {x}_{0} , {x}_{1} , … , {x}_{n} ) {\sum }_{i = 0}^{n} {t}_{i} {d}_{i}^{2} + α {L}_{i}$$

19. The system of claim 12, wherein the weight function has tunable parameters.

20. A non-transitory computer-readable medium comprising instructions which, when executed, cause a map matching system to:
receive a plurality of global positioning system (GPS) data points in a dataset;
receive road map data related to a plurality of roads;
determine a plurality of paths of minimum Fréchet distance for the GPS dataset;
assign a weight to each path of minimum Fréchet distance by applying a weight function; and
output the path with the minimum weight.
